(19) United States
(12) Patent Application Publication
(10) Pub. No.: US 2026/0312761 A1
(43) Pub. Date: Oct. 8, 2026

(54) TRANSMISSION SELECTION IN OVERLAPPING SOUNDING REFERENCE SIGNAL RESOURCE

(71) Applicant: Nokia Technologies Oy, Espoo (FI)

(72) Inventors: Juha Pekka KARJALAINEN, Oulu (FI); Sami-Jukka HAKOLA, Oulu (FI); Timo KOSKELA, Oulu (FI); Youngsoo YUK, Seoul (KR)

(21) Appl. No.: 19/481,679

(22) PCT Filed: Mar. 21, 2024
(86) PCT No.: PCT/EP2024/057532

§ 371 Date: Nov. 5, 2025

(30) Foreign Application Priority Data
May 22, 2023 (GB) 2307649.0

(51) Int. Cl. H04L 5/00; H04W 72/0446; H04W 72/21; H04W 72/51

(52) U.S. Cl. CPC H04L 5/0051; H04W 72/0446; H04W 72/21; H04W 72/51

(57) ABSTRACT

Embodiments relate to apparatus, methods and computer program products which support use of sounding reference signal resource in a wireless communication network. In particular, embodiments relate to apparatus, methods and computer program products which support transmission of a sounding reference signal in the event that resource allocated to the sounding reference signal overlaps with allocation of that resource to a different transmission. According to one embodiment, there may be provided a mobile network node, for example a UE or similar. The UE may comprise at least one processor; and at least one memory storing instructions that, when executed by the at least one processor, cause the network node at least to: receive an indication of a configuration for a single resource sounding reference signal transmission; determine, based on the indication, transmission resource allocated to the single resource sounding reference signal transmission; receive an indication of transmission resource allocated to a physical uplink control channel transmission; evaluate an extent of an overlap between the transmission resource allocated to the single resource sounding reference signal; and select, based on the extent of overlap, what to transmit in the transmission resource allocated to the single resource sounding reference signal transmission. Arrangements provide mechanisms to support UE behaviour in relation to a single resource sounding reference signal transmission for orthogonal frequency division multiplexing symbols associated with the single resource sounding reference signal when such sounding reference signal is determined to overlap, conflict or collide with a physical uplink control channel transmission.

### TECHNOLOGICAL FIELD

Various example embodiments relate to apparatus, methods and computer program products which support use of sounding reference signal resource in a wireless communication network. In particular, embodiments relate to apparatus, methods and computer program products which support transmission of a sounding reference signal in the event that resource allocated to the sounding reference signal overlaps with allocation of that resource to a different transmission.

### BACKGROUND

SRS is a reference signal transmitted by user equipment (UE). A gNB may leverage information in a received SRS to perform uplink radio channel estimation, and to support beam management, codebook selection and/or antenna switching. A received SRS (or SRS set, where various UE uplink configurations are possible) can be used by a gNB in support of a determination of an appropriate uplink MIMO configuration or Precoding configuration to use for downlink communication in a time division duplexing (TDD) arrangement. In summary, use of SRS in a network may be such that uplink transmissions may be optimised, but also (in the case of likely channel reciprocity in a TDD:ed implementation, a channel estimation for uplink based upon a received SRS set can also be utilised for optimizing downlink processes.

SRS has an important role in NR because TDD is the dominant mode of deployment. In TDD a gNB can utilise a channel estimation result from SRS in relation to both UL and DL scheduling based on an assumed level of channel reciprocity.

Whilst SRS has an important role in a wireless communication network, conventional network operation recognises that information in support of uplink communication is provided to a gNB via various other routes. For example, a gNB may be configured to perform UL channel estimation from a Physical Uplink Shared Channel (PUSCH) Demodulation Reference Signal (DMRS), but PUSCH DMRS is transmitted only when PUSCH is scheduled and only with the bandwidth in which PUSCH is scheduled, so the information which a gNB can leverage compared to SRS may be reduced.

Furthermore, configuration of SRS transmission in a network is conventionally such that a SRS transmission is dropped if the resource which may be allocated to SRS transmission is required for a different scheduled transmission, for example, Physical Uplink Control Channel (PUCCH) transmission.

Arrangements recognise that as wireless communication technology deployments have developed, scenarios have arisen which may not be well served by existing techniques. Arrangements seek to provide mechanisms by which such scenarios can be addressed and overall network operation potentially improved.

### BRIEF SUMMARY

The scope of protection sought for various example embodiments of the invention is set out by the independent claims. The example embodiments and features, if any, described in this specification that do not fall under the scope of the independent claims are to be interpreted as examples useful for understanding various embodiments of the invention.

According to various, but not necessarily all, example embodiments, there is provided a mobile network node comprising: at least one processor; and at least one memory storing instructions that, when executed by the at least one processor, cause the network node at least to: receive an indication of a configuration for a single resource sounding reference signal transmission; determine, based on the indication, transmission resource allocated to the single resource sounding reference signal transmission; receive an indication of transmission resource allocated to a physical uplink control channel transmission; evaluate an extent of an overlap between the transmission resource allocated to a physical uplink control channel transmission and the transmission resource allocated to the single resource sounding reference signal; and select, based on the extent of overlap, what to transmit in the transmission resource allocated to the single resource sounding reference signal transmission.

According to some embodiments, the configuration for a single resource sounding reference signal transmission comprises: a configuration for time division multiplexed antenna ports over multiple symbols.

According to some embodiments, evaluating the extent of an overlap comprises: comparing a number of coincident transmission resource and non-co-incident resource between the transmission resource allocated to a physical uplink control channel transmission and the transmission resource allocated to the single resource sounding reference signal transmission.

According to some embodiments, if there is evaluated to be complete overlap between the transmission resource allocated to a physical uplink control channel transmission and the transmission resource allocated to the single resource sounding reference signal transmission, selecting comprises: transmitting the physical uplink control channel transmission in the transmission resource allocated to the single resource sounding reference signal transmission, and dropping transmission of the single resource sounding reference transmission in the transmission resource allocated to the single resource sounding reference signal transmission.

According to some embodiments, if there is evaluated to be a greater number of coincident transmission resource than non-coincident transmission resource, then selecting comprises: transmitting the physical uplink control channel transmission in the coincident transmission resource allocated to the single resource sounding reference signal transmission, and dropping transmission of the single resource sounding reference transmission in the non-coincident transmission resource allocated to the single resource sounding reference signal transmission.

According to some embodiments, if there is evaluated that the number of coincident transmission is equal to or less than non-coincident transmission resource, then selecting comprises: transmitting the physical uplink control channel transmission in the coincident transmission resource allocated to the single resource sounding reference signal transmission, and transmitting at least a part of the single resource sounding reference transmission in the non-coincident transmission resource allocated to the single resource sounding reference signal transmission.

According to some embodiments, the indication of a configuration for a single resource sounding reference signal transmission comprises: an indication of orthogonal frequency-division multiplexing symbols within a slot allocated to the single resource sounding reference signal transmission.

According to some embodiments, the indication of transmission resource allocated to a physical uplink control channel transmission comprises: an indication of orthogonal frequency-division multiplexing symbols within a slot allocated to the physical uplink control channel transmission.

According to some embodiments, evaluating the extent of the overlap comprises:
determining whether a number of non-overlapping symbols is less than a time domain multiplexing factor associated with the single resource sounding reference signal transmission.

According to some embodiments, the time domain multiplexing factor comprises: an indication of a subset of antenna ports mapped onto at least two symbols sharing the same frequency resource with repetition in a slot, and wherein a total number of symbols of sounding reference signal resource allocated to time division multiplexed antenna ports with repetition is given by the multiplexing factor multiplied by a repetition factor.

According to some embodiments, if there is evaluated to be a greater number of overlapping symbols than non-overlapping signals, then selecting comprises:
transmitting the physical uplink control channel transmission in the overlapping symbols, and dropping transmission of the single resource sounding reference transmission in the non-overlapping symbols.

According to some embodiments, if there is evaluated that the number of overlapping symbols is equal to or less than non-overlapping symbols, then selecting comprises:
transmitting the physical uplink control channel transmission in the overlapping symbols, and transmitting at least a part of the single resource sounding reference transmission in the non-overlapping symbols.

According to some embodiments, selecting comprises: selecting to transmit the physical uplink control channel transmission in the transmission resource allocated to the single resource sounding reference signal transmission in the overlap, and based on the evaluated extent of overlap, the network node is caused to:
reformulate the single resource sounding reference signal transmission for transmission in the non-overlapping transmission resource allocated to the single resource sounding reference signal transmission; and
transmit the reformulated single resource sounding reference signal in the non-overlapping transmission resource allocated to the single resource sounding reference signal transmission.

According to some embodiments, the reformulated single resource sounding reference signal transmission comprises: an equivalent number of repeated time domain multiplexed antenna ports as that in the received configuration for a single resource sounding reference signal transmission.

According to some embodiments, the reformulated single resource sounding reference signal transmission comprises: information equivalent to that contained in the single resource sounding reference signal transmission in the overlap of transmission resource allocated to the single resource sounding reference signal transmission with the physical uplink control channel transmission.

According to some embodiments, the mobile network node is caused to:
determine whether adequate power is available for transmission of the physical uplink control channel transmission and the single resource sounding reference signal transmission within the overlap between the transmission resource allocated to a physical uplink control channel transmission and the transmission resource allocated to the single resource sounding reference signal transmission; and wherein
selecting what to transmit in the transmission resource allocated to the single resource sounding reference signal transmission is based on the extent of the overlap and the determination of whether adequate power is available.

According to some embodiments, the mobile network node is caused to:
determine a spatial relation between the physical uplink control channel transmission and the single resource sounding reference signal transmission; and wherein
selecting what to transmit in the transmission resource allocated to the single resource sounding reference signal transmission is based on the extent of the overlap and the determination of the spatial relation.

According to some embodiments, the mobile network node is caused to:
determine it has multiple panel uplink capability enabled; and wherein
selecting what to transmit in the transmission resource allocated to the single resource sounding reference signal transmission is based on the extent of the overlap and whether multiple panel uplink capability is enabled.

According to some embodiments, the mobile network node comprises user equipment comprising circuitry configured to generate radio frequency signals.

According to some embodiments, the mobile network node is configured to make a transmission in accordance with the selection.

According to various, but not necessarily all, example embodiments, there is provided a mobile network node comprising: means to receive an indication of a configuration for a single resource sounding reference signal transmission; means to determine, based on the indication, transmission resource allocated to the single resource sounding reference signal transmission; means to receive an indication of transmission resource allocated to a physical uplink control channel transmission; means to evaluate an extent of an overlap between the transmission resource allocated to a physical uplink control channel transmission and the transmission resource allocated to the single resource sounding reference signal; and means to select, based on the extent of overlap, what to transmit in the transmission resource allocated to the single resource sounding reference signal transmission.

The means may perform the optional features set out in relation to the apparatus mentioned above.

According to various, but not necessarily all, example embodiments, there is provided a mobile network node comprising: circuitry to receive an indication of a configuration for a single resource sounding reference signal transmission; circuitry configured to determine, based on the indication, transmission resource allocated to the single resource sounding reference signal transmission; circuitry configured to receive an indication of transmission resource allocated to a physical uplink control channel transmission; circuitry configured to evaluate an extent of an overlap between the transmission resource allocated to a physical uplink control channel transmission and the transmission resource allocated to the single resource sounding reference signal; and circuitry configured to select, based on the extent of overlap, what to transmit in the transmission resource allocated to the single resource sounding reference signal transmission.

The circuitry may be configured perform the optional features set out in relation to the apparatus mentioned above.

According to various, but not necessarily all, example embodiments, there is provided a mobile network node method, comprising: receiving an indication of a configuration for a single resource sounding reference signal transmission; determining, based on the indication, transmission resource allocated to the single resource sounding reference signal transmission; receiving an indication of transmission resource allocated to a physical uplink control channel transmission; evaluating an extent of an overlap between the transmission resource allocated to a physical uplink control channel transmission and the transmission resource allocated to the single resource sounding reference signal transmission; and selecting, based on the extent of overlap, what to transmit in the transmission resource allocated to the single resource sounding reference signal transmission.

According to some embodiments, the configuration for a single resource sounding reference signal transmission comprises: a configuration for time division multiplexed antenna ports over multiple symbols.

According to some embodiments, evaluating the extent of an overlap comprises:
comparing a number of coincident transmission resource and non-co-incident resource between the transmission resource allocated to a physical uplink control channel transmission and the transmission resource allocated to the single resource sounding reference signal transmission.

According to some embodiments, if there is evaluated to be complete overlap between the transmission resource allocated to a physical uplink control channel transmission and the transmission resource allocated to the single resource sounding reference signal transmission, selecting comprises: transmitting the physical uplink control channel transmission in the transmission resource allocated to the single resource sounding reference signal transmission, and dropping transmission of the single resource sounding reference transmission in the transmission resource allocated to the single resource sounding reference signal transmission.

According to some embodiments, if there is evaluated to be a greater number of coincident transmission resource than non-coincident transmission resource, then selecting comprises: transmitting the physical uplink control channel transmission in the coincident transmission resource allocated to the single resource sounding reference signal transmission, and dropping transmission of the single resource sounding reference transmission in the non-coincident transmission resource allocated to the single resource sounding reference signal transmission.

According to some embodiments, if there is evaluated that the number of coincident transmission is equal to or less than non-coincident transmission resource, then selecting comprises: transmitting the physical uplink control channel transmission in the coincident transmission resource allocated to the single resource sounding reference signal transmission, and transmitting at least a part of the single resource sounding reference transmission in the non-coincident transmission resource allocated to the single resource sounding reference signal transmission.

According to some embodiments, the indication of a configuration for a single resource sounding reference signal transmission comprises: an indication of orthogonal frequency-division multiplexing symbols within a slot allocated to the single resource sounding reference signal transmission.

According to some embodiments, the indication of transmission resource allocated to a physical uplink control channel transmission comprises: an indication of orthogonal frequency-division multiplexing symbols within a slot allocated to the physical uplink control channel transmission.

According to some embodiments, evaluating the extent of the overlap comprises:
determining whether a number of non-overlapping symbols is less than a time domain multiplexing factor associated with the single resource sounding reference signal transmission.

According to some embodiments, the time domain multiplexing factor comprises: an indication of a subset of antenna ports mapped onto at least two symbols sharing the same frequency resource with repetition in a slot, and wherein a total number of symbols of sounding reference signal resource allocated to time division multiplexed antenna ports with repetition is given by the multiplexing factor multiplied by a repetition factor.

According to some embodiments, if there is evaluated to be a greater number of overlapping symbols than non-overlapping signals, then selecting comprises:
transmitting the physical uplink control channel transmission in the overlapping symbols, and dropping transmission of the single resource sounding reference transmission in the non-overlapping symbols.

According to some embodiments, if there is evaluated that the number of overlapping symbols is equal to or less than non-overlapping symbols, then selecting comprises:
transmitting the physical uplink control channel transmission in the overlapping symbols, and transmitting at least a part of the single resource sounding reference transmission in the non-overlapping symbols.

According to some embodiments, selecting comprises: selecting to transmit the physical uplink control channel transmission in the transmission resource allocated to the single resource sounding reference signal transmission in the overlap, and based on the evaluated extent of overlap, the network node is caused to:
reformulate the single resource sounding reference signal transmission for transmission in the non-overlapping transmission resource allocated to the single resource sounding reference signal transmission; and
transmit the reformulated single resource sounding reference signal in the non-overlapping transmission resource allocated to the single resource sounding reference signal transmission.

According to some embodiments, the reformulated single resource sounding reference signal transmission comprises: an equivalent number of repeated time domain multiplexed antenna ports as that in the received configuration for a single resource sounding reference signal transmission.

According to some embodiments, the reformulated single resource sounding reference signal transmission comprises: information equivalent to that contained in the single resource sounding reference signal transmission in the overlap of transmission resource allocated to the single resource sounding reference signal transmission with the physical uplink control channel transmission.

According to some embodiments, the mobile network node is caused to:
determine whether adequate power is available for transmission of the physical uplink control channel transmission and the single resource sounding reference signal transmission within the overlap between the transmission resource allocated to a physical uplink control channel transmission and the transmission resource allocated to the single resource sounding reference signal transmission; and wherein
selecting what to transmit in the transmission resource allocated to the single resource sounding reference signal transmission is based on the extent of the overlap and the determination of whether adequate power is available.

According to some embodiments, the mobile network node is caused to: determine a spatial relation between the physical uplink control channel transmission and the single resource sounding reference signal transmission; and wherein
selecting what to transmit in the transmission resource allocated to the single resource sounding reference signal transmission is based on the extent of the overlap and the determination of the spatial relation.

According to some embodiments, the mobile network node is caused to:
determine it has multiple panel uplink capability enabled; and wherein selecting what to transmit in the transmission resource allocated to the single resource sounding reference signal transmission is based on the extent of the overlap and whether multiple panel uplink capability is enabled.

According to some embodiments, the method comprises making a transmission in accordance with the selection.

According to various, but not necessarily all, example embodiments, there is provided a computer program product operable, when executed by a computer, to perform a method comprising: receiving an indication of a configuration for a single resource sounding reference signal transmission; determining, based on the indication, transmission resource allocated to the single resource sounding reference signal transmission; receiving an indication of transmission resource allocated to a physical uplink control channel transmission; evaluating an extent of an overlap between the transmission resource allocated to a physical uplink control channel transmission and the transmission resource allocated to the single resource sounding reference signal transmission; and selecting, based on the extent of overlap, what to transmit in the transmission resource allocated to the single resource sounding reference signal transmission.

The computer program product may be operable, when executed on a computer, to perform the optional features set out in relation to the method mentioned above.

According to various, but not necessarily all, example embodiments, there is provided a non-transitory computer readable medium comprising program instructions stored thereon for performing at least the following: receiving an indication of a configuration for a single resource sounding reference signal transmission; determining, based on the indication, transmission resource allocated to the single resource sounding reference signal transmission; receiving an indication of transmission resource allocated to a physical uplink control channel transmission; evaluating an extent of an overlap between the transmission resource allocated to a physical uplink control channel transmission and the transmission resource allocated to the single resource sounding reference signal transmission; and selecting, based on the extent of overlap, what to transmit in the transmission resource allocated to the single resource sounding reference signal transmission.

The instructions may be for performing the optional features set out in relation to the method mentioned above.

According to various, but not necessarily all, example embodiments, there is provided a network node comprising: at least one processor; and at least one memory storing instructions that, when executed by the at least one processor, cause the network node at least to: determine an indication of a configuration for a single resource sounding reference signal transmission; the configuration comprising: one or more condition to be applied by a mobile network node to select what to transmit in transmission resource allocated to the single resource sounding reference signal transmission, the selection being based upon an evaluated extent of an overlap between transmission resource allocated to a physical uplink control channel transmission and the transmission resource allocated to the single resource sounding reference signal transmission; and provide the determined indication to the mobile network node.

According to some embodiments, the configuration for a single resource sounding reference signal transmission comprises: a configuration for time division multiplexed antenna ports over multiple symbols.

According to some embodiments, the indication of a configuration for a single resource sounding reference signal transmission comprises: an indication of orthogonal frequency-division multiplexing symbols within a slot allocated to the single resource sounding reference signal transmission.

According to some embodiments, the indication of transmission resource allocated to a physical uplink control channel transmission comprises: an indication of orthogonal frequency-division multiplexing symbols within a slot allocated to the physical uplink control channel transmission.

According to some embodiments, the configuration comprises: a time domain multiplexing factor associated with the single resource sounding reference signal transmission.

According to some embodiments, the time domain multiplexing factor comprises: an indication of a subset of antenna ports mapped onto at least two symbols sharing the same frequency resource with repetition in a slot, and wherein a total number of symbols of sounding reference signal resource allocated to time division multiplexed antenna ports with repetition is given by the multiplexing factor multiplied by a repetition factor.

According to some embodiments, the network node is configured to determine a configuration of a reformulated single resource sounding reference signal transmitted by a mobile network node.

According to some embodiments, the reformulated single resource sounding reference signal transmission comprises: an equivalent number of repeated time domain multiplexed antenna ports as that in the received configuration for a single resource sounding reference signal transmission.

According to various, but not necessarily all, example embodiments, there is provided a network node comprising: means to determine an indication of a configuration for a single resource sounding reference signal transmission; the configuration comprising: one or more condition to be applied by a mobile network node to select what to transmit in transmission resource allocated to the single resource sounding reference signal transmission, the selection being based upon an evaluated extent of an overlap between transmission resource allocated to a physical uplink control channel transmission and the transmission resource allocated to the single resource sounding reference signal transmission; and means to provide the determined indication to the mobile network node.

The means may perform the optional features set out in relation to the apparatus mentioned above.

According to various, but not necessarily all, example embodiments, there is provided a network node comprising: circuitry configured to determine an indication of a configuration for a single resource sounding reference signal transmission; the configuration comprising: one or more condition to be applied by a mobile network node to select what to transmit in transmission resource allocated to the single resource sounding reference signal transmission, the selection being based upon an evaluated extent of an overlap between transmission resource allocated to a physical uplink control channel transmission and the transmission resource allocated to the single resource sounding reference signal transmission; and circuitry configured to provide the determined indication to the mobile network node.

The circuitry may be configured perform the optional features set out in relation to the apparatus mentioned above.

According to various, but not necessarily all, example embodiments, there is provided a network node method comprising: determining an indication of a configuration for a single resource sounding reference signal transmission; the configuration comprising:
one or more condition to be applied by a mobile network node to select what to transmit in transmission resource allocated to the single resource sounding reference signal transmission, the selection being based upon an evaluated extent of an overlap between transmission resource allocated to a physical uplink control channel transmission and the transmission resource allocated to the single resource sounding reference signal transmission; and providing the determined indication to the mobile network node.

According to some embodiments, the configuration for a single resource sounding reference signal transmission comprises: a configuration for time division multiplexed antenna ports over multiple symbols.

According to some embodiments, the indication of a configuration for a single resource sounding reference signal transmission comprises: an indication of orthogonal frequency-division multiplexing symbols within a slot allocated to the single resource sounding reference signal transmission.

According to some embodiments, the indication of transmission resource allocated to a physical uplink control channel transmission comprises: an indication of orthogonal frequency-division multiplexing symbols within a slot allocated to the physical uplink control channel transmission.

According to some embodiments, the configuration comprises: a time domain multiplexing factor associated with the single resource sounding reference signal transmission.

According to some embodiments, the time domain multiplexing factor comprises: an indication of a subset of antenna ports mapped onto at least two symbols sharing the same frequency resource with repetition in a slot, and wherein a total number of symbols of sounding reference signal resource allocated to time division multiplexed antenna ports with repetition is given by the multiplexing factor multiplied by a repetition factor.

According to some embodiments, the network node is configured to determine a configuration of a reformulated single resource sounding reference signal transmitted by a mobile network node.

According to some embodiments, the reformulated single resource sounding reference signal transmission comprises: an equivalent number of repeated time domain multiplexed antenna ports as that in the received configuration for a single resource sounding reference signal transmission.

According to various, but not necessarily all, example embodiments, there is provided a computer program product operable, when executed by a computer, to perform a method comprising: determining an indication of a configuration for a single resource sounding reference signal transmission; the configuration comprising: one or more condition to be applied by a mobile network node to select what to transmit in transmission resource allocated to the single resource sounding reference signal transmission, the selection being based upon an evaluated extent of an overlap between transmission resource allocated to a physical uplink control channel transmission and the transmission resource allocated to the single resource sounding reference signal transmission; and providing the determined indication to the mobile network node.

The computer program product may be operable, when executed on a computer, to perform the optional features set out in relation to the method mentioned above.

According to various, but not necessarily all, example embodiments, there is provided:
a non-transitory computer readable medium comprising program instructions stored thereon for performing at least the following: determining an indication of a configuration for a single resource sounding reference signal transmission; the configuration comprising: one or more condition to be applied by a mobile network node to select what to transmit in transmission resource allocated to the single resource sounding reference signal transmission, the selection being based upon an evaluated extent of an overlap between transmission resource allocated to a physical uplink control channel transmission and the transmission resource allocated to the single resource sounding reference signal transmission; and providing the determined indication to the mobile network node.

The instructions may be for performing the optional features set out in relation to the method mentioned above.

Further particular and preferred aspects are set out in the accompanying independent and dependent claims. Features of the dependent claims may be combined with features of the independent claims as appropriate, and in combinations other than those explicitly set out in the claims.

Where an apparatus feature is described as being operable to provide a function, it will be appreciated that this includes an apparatus feature which provides that function or which is adapted or configured to provide that function.

### BRIEF DESCRIPTION

Some example embodiments will now be described with reference to the accompanying drawings in which:

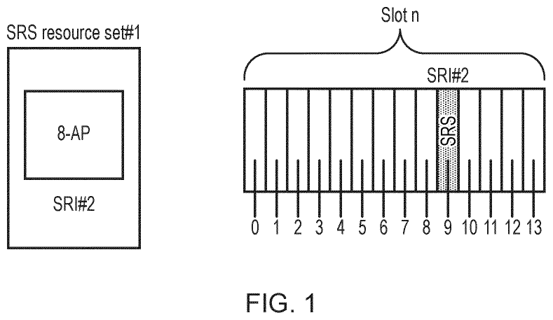

FIG. 1 illustrates schematically configuration of a Rel-18 UL SRS for a UE set to usage antenna-switching 8T8R;

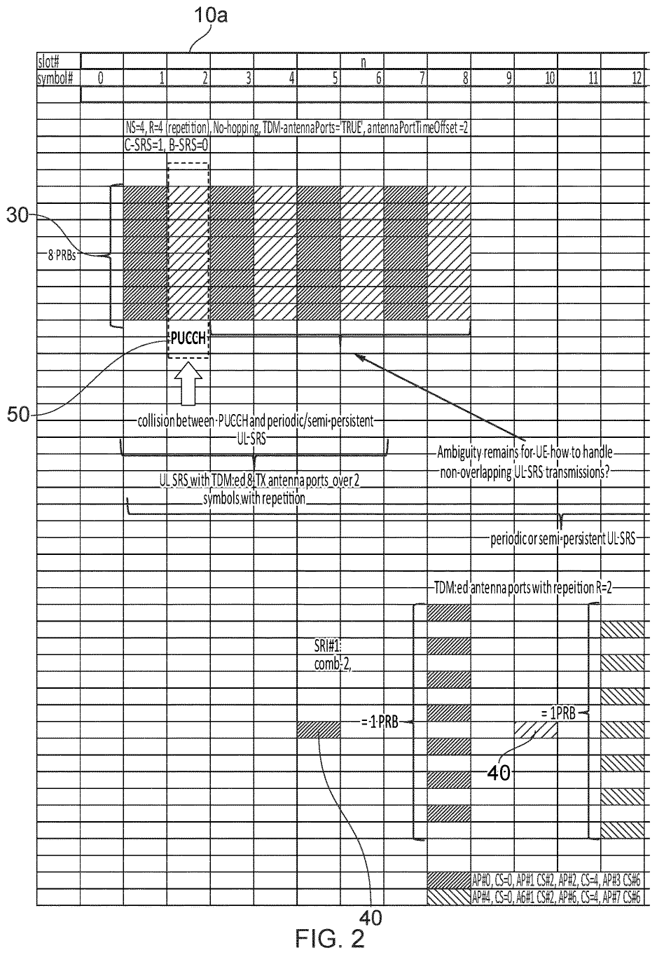

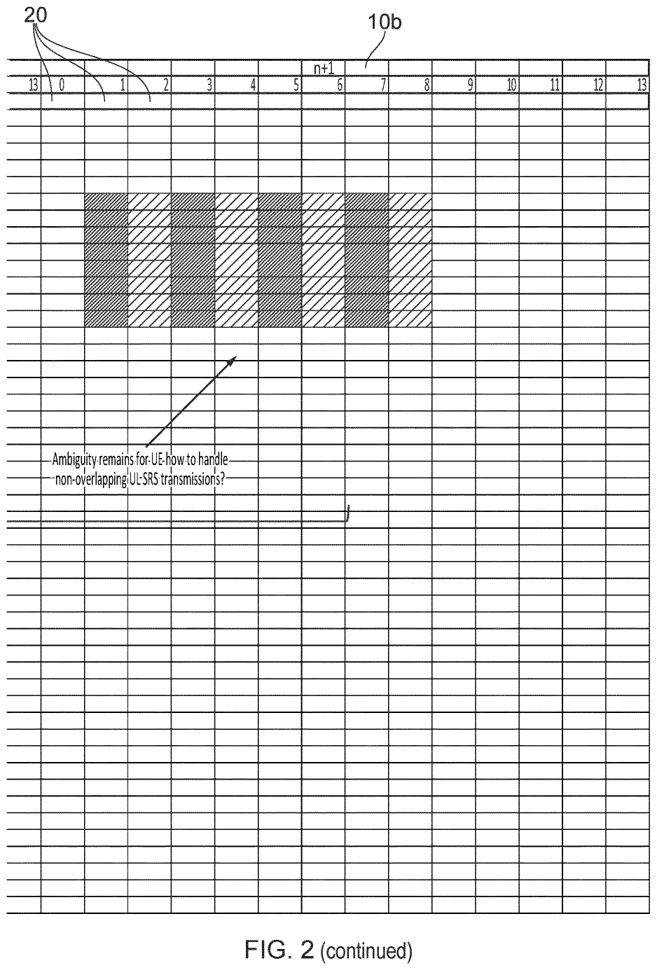

FIG. 2 illustrates schematically an interaction between a Physical Uplink Control Channel (PUCCH) and a Sounding Reference Signal (SRS) in an Uplink (UL) SRS for a UE having 8 TDM: ed transmission ports, and an SRS configuration with a repetition factor of 4;

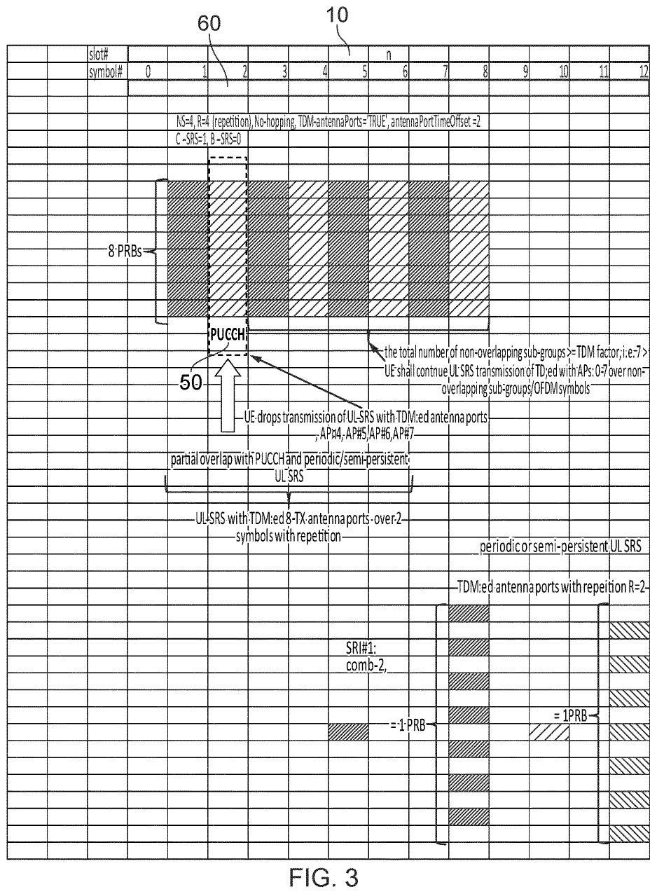

FIG. 3 illustrates schematically an example embodiment of the subject matter described herein;

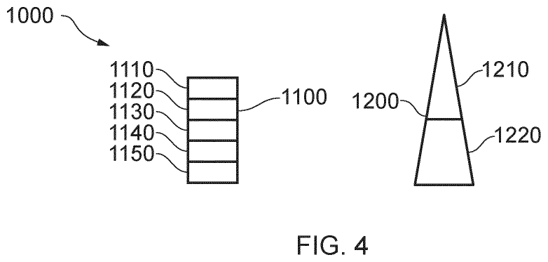

FIG. 4 illustrates schematically some components of a wireless communication network including nodes according to some arrangements; and

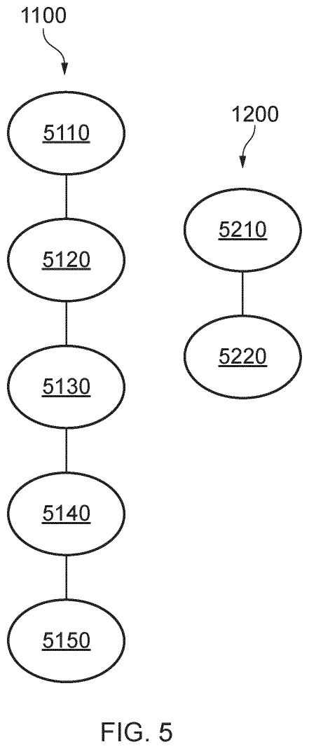

FIG. 5 illustrates schematically steps of methods performed at nodes in accordance with some arrangements.

### DETAILED DESCRIPTION

Before discussing the example embodiments in any more detail, first an overview of a context in which arrangements can be understood will be provided.

Arrangements relate generally to mechanisms by which a Sounding Reference Signal (SRS) can be implemented by nodes in a wireless communication network.

Arrangements relate to 3GPP New Radio (NR) physical layer design for multiple input multiple output (MIMO) enhancements in Release-18 and beyond. More specifically, arrangements relate to a dropping mechanism and corresponding UE transmission procedure suitable for use, for example, with a 8 transmission (TX) antenna port (AP) single resource Uplink (UL) sounding reference signal (SRS) transmission with time division multiplexed (TDM): ed antenna ports with multiple OFDM symbols.

By way of background in relation to SRS and UE operation: the NR Rel-17 specification provides support for single user downlink (DL) physical downlink shared channel (PDSCH) scheduling having up to 8 layers (in other words, rank 8 operation).

However, a Rel-15 UL SRS resource configuration with antenna switching can only provide support for user equipment (UE) which are equipped with 4 reception (RX) antenna ports. In other words, even though a UE may be equipped with 8 RX antenna ports, only four out of those eight antenna ports can be used for DL Channel State Information (CSI) acquisition at the gNB-side based upon UL SRS sounding. It will be appreciated that such a limitation may result in suboptimal use of potential performance gains available using DL transmission precoding. Furthermore, reception processing may also limit overall available system performance, for example, in terms of spectral efficiency and interference mitigation.

Nr Rel-17 supports the following SRS time domain behaviors:
periodic;
semi-persistent; and
aperiodic transmission.

With semi-persistent SRS transmission, Medium Access Control Control Elements (MAC-CE) are used to activate and deactivate a semi-persistent set of one or more SRS resources. While activated, a semi-persistent UL SRS resource is transmitted with a configured periodicity and slot offset. As a result, a more dynamic on/off control is enabled compared to, for example, periodic SRS transmission, where resources are configured by Radio Resource Control RRC signaling.

In Rel-17, depending on a reported UE's antenna-switching capability, a UE can be configured with a higher layer parameter “usage” in “SRS-Resource Set” set to ‘antennaSwitching’, and the UE may be configured to operate in accordance with one of the following configurations depending on the indicated UE capability supportedSRS-TxPortSwitch (‘t1r2’ for 1T2R, ‘t1r1-t1r2’ for 1T=1R/1T2R, ‘t2r4’ for 2T4R, ‘t1r4’ for 1T4R, ‘t1r6’ for 1T6R, ‘t1r8’ for 1T8R, ‘t2r6’ for 2T6R, ‘t2r8’ for 2T8R, ‘t4r 8’ for 4T8R, ‘t1r1-t1r2-t1r4’ for 1T=1R/1T2R/1T4R, ‘t1r4-t2r4’ for 1T4R/2T4R, ‘t1r1-t1r2-t2r2-t2r4’ for 1T=1R/1T2R/2T=2R/2T4R, ‘t1r1-t1r2-t2r2-t1r4-t2r4’ for 1T=1R/1T2R/2T=2R/1T4R/2T4R, ‘t1r1’ for T=1R, ‘t2r2’ for 2T=2R, ‘t1r1-t2r2’ for 1T=1R/2T=2R, ‘t4r4’ for 4T=4R, or ‘t1r1-t2r2-t4r4’ for 1T=1R/2T=2R/4T=4R),
where T and R define the number of transmission antenna ports and reception antenna ports at the UE-side, respectively.

The indicated UE antenna switching capability of ‘xTyR’ corresponds to a UE, capable of SRS transmission on ‘x’ antenna ports over total of ‘y’ antennas, where ‘y’ corresponds to all, or a subset of all, available UE receive antennas. Again, it can be seen that such a limitation may result in suboptimal use of potential performance gains available using DL transmission precoding.

It will also be appreciated that a UE is conventionally configured with a guard period of Y symbols, in which the UE does not transmit any other signal, in the case the SRS resources of a set are transmitted in the same slot. The guard period is provided in-between the SRS resources of the set. For example, for two SRS resource sets of an antenna switching located in two consecutive slots, if a UE is capable of transmitting SRS in all symbols in one slot, a guard period of Y symbols exists between the last OFDM symbol occupied by the SRS resource set in the first slot and a first OFDM symbol occupied by the SRS resource set in the second slot. Such a guard period allows for implementation of a physical reconfiguration at the UE to a different antenna port arrangement. For an inter-set guard period, the UE does not transmit any other signal on any symbols of the interval if the interval between SRS resource sets is Y symbols.

Conventionally, in circumstances where the SRS resource on all of the corresponding symbols prior to the gap/guard period are dropped and the SRS resource on all of the corresponding symbols after the gap are dropped, for example, as a result of collision handling, the gap period is also dropped with same priority and can be used for UL transmission.

In accordance with Rel-17, UE operation is such that a UE expects to be configured with the same number of SRS ports for all SRS resources in an SRS resource set(s) with higher layer parameter usage set as ‘antennaSwitching’.

For 1T2R, 1T4R or 2T4R, or 1T6R or 1T8R, 2T6R, 2T8R, 4T8R, the UE does not expect to be configured or triggered with more than one SRS resource set with higher layer parameter usage set as ‘antennaSwitching’ in the same slot. For 1T=1R, 2T=2R or 4T=4R, the UE does not expect to be configured or triggered with more than one SRS resource set with higher layer parameter usage set as ‘antennaSwitching’ in the same symbol.

The Rel-17 specification defines the way in which antenna ports for the UL SRS resource are configured with repetition (and without SRS frequency hopping) as follows: When frequency hopping within an SRS resource in each slot is not configured (R=Ns), each of the antenna ports of the SRS resource in each slot is mapped in all the Ns symbols to the same set of subcarriers in the same set of Physical Resource Blocks (PRBs), where R is SRS repetition factor.

When frequency hopping within an SRS resource in each slot is configured without repetition (R=1), according to the SRS hopping parameters SRS B, SRS C and hop b defined in clause 6.4.1.4 of [4, TS 38.211] of the specification, each of the antenna ports of the SRS resource in each slot is mapped to different sets of subcarriers in each OFDM symbol, where the same transmission comb value is assumed for different sets of subcarriers.

When both frequency hopping and repetition within an SRS resource in each slot are configured (Ns≥4, R≥2), each of the antenna ports of the SRS resource in each slot is mapped to the same set of subcarriers within each set of R adjacent OFDM symbols, and frequency hopping across the Ns, R, sets is performed according to the SRS hopping parameters SRS B, SRS C and hop b, where Ns is divisible by R.

In Rel-18, it was recognized that enhancements to SRS for uplink MIMO could be addressed. In particular, it is recognized that achieving a higher peak data rate for UL could play a significant role in short-range applications such as: home entertainment, video surveillance/monitoring in industrial/healthcare/safety, Integrated Access and Backhaul (IAB), and other similar applications. This may particularly apply where UE devices have requirements in relation to power, form-factor and cost which are not as stringent as in a traditional handheld UE device.

UL transmission where use of more than 4 transmission antenna ports is possible is recognised as being a useful tool to bridge the gap between DL and UL spectral efficiency, in both Frequency Range 1 (FR1) and Frequency Range 2 (FR2). There is, therefore, a need to develop methods and/or signalling solutions to support such a UE configuration.

One objective of Rel-18 NR MIMO Evo DL UL, is to address how to provide specification support for simultaneous multi-panel UL transmission with 2 panels (STx2P). In particular, an objective is to enhance the specification to enable 8 Tx UL operation and support four (and more) layers per UE in UL. It is recognized that such an enhancement may have particular application in relation to UE which take the form of Customer Premises Equipment (CPE); Fixed Wireless Access (FWA) devices; vehicle UE devices and industrial devices.

In support of such enhancements, it has been agreed that for the maximum number of SRS resource sets for SRS with 8T8R with ‘antenna Switching’, to use the existing value of the maximum number of SRS resource sets (as provided in Rel-17 antenna switching nTnR).

It has also been agreed that 8 TX antenna ports will be supported in Rel-18 for UL SRS with usage antenna-switching. Based on this, a UE can be configured with one OFDM symbol for 8 TX UL SRS with antenna-switching, as shown in FIG. 1. FIG. 1 illustrates schematically configuration of a Rel-18 UL SRS for a UE set to usage antenna-switching 8T8R.

A UE may be configured to support more than one OFDM symbol where different antenna ports are mapped to different symbols for 8 TX UL SRS with antenna-switching. Moreover, one or more OFDM symbol may be configured for UL SRS usage with codebook. A UE can be configured with a single UL SRS resource in a SRS resource set with usage ‘codebook’ or ‘antennaSwitching’ for 8TX PUSCH with 8 ports with TDM factor s>1, s=2, [4,8], where subset of antenna ports are mapped over m OFDM symbols (≥2) in a slot where each of m symbols/subsets comprise 8/s different antenna ports.

A UE can be configured with an UL SRS resource set with usage ‘codebook’ or ‘antennaSwitching’ with TDM factor s>1 when the s subsets of ports are mapped onto m≥2 OFDM symbols sharing same frequency resources (i.e resource elements) with repetition in a slot according to the pattern {{1, 2, . . . , s}, . . . , {1, 2, . . . , s}}. The total number of symbols of SRS resource with TDM antenna ports and repetition is SRS TDM factor times(S) SRS repetition factor (R).

It is possible that UL SRS Can Be Dropped in Certain Conditions

Rel-18 also provides support for UL SRS resource set configuration with usage ‘codebook/antenna-switching’ a single UL SRS resource configuration where multiple antenna ports, (i.e. up to 8 antenna ports (AP)s), where UL SRS for antenna ports can be distributed in a TDM manner across time over multiple OFDM symbols.

FIG. 2 illustrates schematically interaction between a Physical Uplink Control Channel (PUCCH) and a Sounding Reference Signal (SRS) in an Uplink (UL) SRS for a UE having 8 TDM:ed SRS transmission ports, and an SRS configuration with a repetition factor of 4. FIG. 2 shows an example of overlap with PUCCH (with format 1/2/3) and a periodic or semi-persistent UL SRS with 8 TDM:ed antenna ports over two symbols with repetition factor of 4.

In the example shown in FIG. 2, a UE is configured with single UL SRS resource with 8-TX antenna ports having time division multiplexed (TDM): ed antenna ports with repetition factor of 4. FIG. 2 illustrates 2 slots: 10a, 10b (slots n, n+1 respectively). In the example of FIG. 2, there is shown a periodic, or semi-persistent UL SRS configuration—it can be seen that both slots 10a and 10b have an SRS allocation of resource.

Each slot 10 generally comprises 14 orthogonal frequency-division multiplexing (OFDM) symbols 20.

The SRS resource allocation in the arrangement of FIG. 2 is shown spanning a region 30 which comprises 8 Physical Resource Blocks (PRB).

Moreover in the example shown in FIG. 2, the UL SRS resource is configured with comb-2, as shown schematically in relation to Physical Resource Blocks 40 (generally comprising 14 time blocks of 12 consecutive frequency subcarriers) having a re-offset set to 0 for AP#0, AP#1, AP#2, AP#3 with a cyclic-shift (CS)=0, 2, 4, 6, respectively and re-offset set to 1 for AP#4, AP#5, AP#6, AP#7 with a cyclic-shift (CS)=0, 2, 4, 6, respectively.

As shown in FIG. 2, an overlap of PUCCH transmission 50 (for example, having format 1/2/3) occurs with the periodic/semi-persistent UL SRS transmission having TDM: ed antenna ports with repetition in the slot n (10a). If following conventional UE behaviour, as defined in the 3GPP specification, the UE is configured such that it drops the entire UL SRS transmission (i.e. the entire SRS transmission in slot 10a (slot n)) which is deemed to conflict with the overlapping PUCCH transmission 50. In other words, the UE is configured to prioritize PUCCH transmission 50 over UL SRS transmission, independent of the extent of the overlap. That is to say, a SRS transmission which collides with resource used for PUCCH is dropped, irrespective of whether the overlap is partial or total. It will be appreciated that such dropping of SRS, especially in a case where single resource UL SRS with TDM:ed antenna ports with repetition is implemented, is likely to lead to an overall latency increase in network operation and represents inefficient use of available radio resources.

Arrangements recognize that Rel-18 supports a single UL SRS resource configuration where up to 8 SRS antenna ports can be distributed in a TDM manner across time over multiple OFDM symbols. It is recognizes that overlap might occur between scheduled PUCCH transmission and, for example, a aperiodic/periodic/semi-persistent single resource UL SRS with TDM: ed antenna ports operating with repetition. Such a scenario is illustrated schematically in FIG. 2.

Arrangements recognize that some flexibility remains in the 3GPP standards regarding definition of UE behavior when overlap of, for example, PUCCH, with aperiodic/periodic/semi-persistent single resource UL SRS with TDM: ed antenna ports with repetition (i.e. repetition factor >1) occurs.

Arrangements seek to provide mechanisms to support appropriate UE and network operation in relation to SRS techniques with SRS resource set usage configured as codebook/antenna-switching, non-codebook.

Arrangements seek to provide mechanisms to support UE behaviour in relation to a single resource SRS transmission for OFDM symbols associated with the single resource SRS when such SRS is determined to overlap, conflict or collide with a PUCCH transmission. The behaviour of a UE, in accordance with arrangements, is such that it is at least partly based upon an extent to which the SRS and PUCCH resource is determined to overlap. For example, the extent of overlap may be determined based upon an evaluated number of non-overlapping (also known as clear, unobstructed or uncontended) symbols, N, and/or number of overlapping symbols M, where M=L-N, where the total number of symbols/transmission occasions, L, of single SRS resource associated with TDM:ed antenna ports and repetition (i.e. TDM factor times repetition factor=S×R=L).

By way of example, if it is determined that the number of clear (non-overlapping) symbols, N, associated with different TDM:ed SRS antenna ports is less than a time domain multiplexing factor, i.e. N<S associated with the single resource SRS transmission TDM factor, S, then a UE may be configured to drop the whole of the SRS transmission (that is to say, it prioritizes the PUCCH transmission). It can be understood that such an approach is appropriate since the information being conveyed in any clear SRS symbols is likely to be insufficiently useful to overall network operation.

By way of further example, if it is determined that the number of clear (non-overlapping) symbols with different TDM:ed SRS antenna ports is equal to, or larger than, a time domain multiplexing factor, i.e. N≥S, associated with the single resource SRS transmission TDM factor, then a UE may be configured to apply one or more pre-determined transmission rule-set and drop a part of an SRS transmission corresponding to the overlapping symbols (i.e. prioritizes the PUCCH transmission on the overlapping symbols). However, the rule set may be such that the UE may be configured, in relation to clear (non-overlapping) symbols, so that it transmits the part of the SRS transmission which corresponded to the non-overlapping symbols. The pre-determined rule-set may define the condition for UL SRS transmission so that when N≥S the UE is configured to drop SRS transmission in the overlapping, M=L-N, symbols and transmit N symbols associated with different TDM:ed antenna ports out of the number of total L symbols. It is worth noting that the number of TDM:ed SRS antenna ports associated with different antenna ports needs to full fill the condition N≥S to enable transmission of single SRS resource transmission with non-overlapping symbols. It can be understood that such an approach is appropriate since the information being conveyed in the clear SRS symbols is likely to be useful to overall network operation.

In an alternative, where it is determined that the number of clear (non-overlapping) symbols is equal to, or larger than, a time domain multiplexing factor associated with the single resource SRS transmission TDM factor (N≥S), then a UE may be configured with a rule-set to drop a part of an SRS transmission corresponding to the overlapping symbols (i.e. prioritizes the PUCCH transmission on the overlapping symbols), however, the UE may be configured, in relation to clear (non-overlapping) symbols, such that it transmits the dropped part of the SRS transmission and the remainder of the SRS transmission using the clear symbols in a manner defined to provide an equal number of repeated time domain multiplexed antenna ports over a time duration of the single resource SRS transmission.

Having described a general overview of an arrangement, more detail regarding some possible implementations is provided.

According to one implementation of an arrangement, a transmission rule-set to be applied in relation to single resource UL SRS with TDM:ed antenna ports and repetition with partially overlapping PUCCH transmission is defined. Such a transmission rule-set may define an implicit indication method to trigger appropriate UE operation in relation to dropping and transmission of single resource SRS transmission with TDM: ed antenna ports and repetition when it is determined that such SRS transmission partially overlaps with, for example, PUCCH resource. It will be appreciated that partial as used in this context means that the PUCCH resource overlaps with a subset of SRS symbols, i.e. M=L-N number of symbols, in a slot.

According to one possible transmission rule set, where it is determined that there is a partial overlap of, for example, PUCCH with UL SRS with TDM:ed antenna ports and repetition, an assessment may be made as to whether a first set of TDM:ed antenna ports, covering different TDM:ed antenna ports, associated with sub-groups/OFDM symbols of single SRS resource overlap in time with, for example, PUCCH resource. An assessment may also be made as to whether a second set of TDM:ed antenna ports associated with sub-groups/OFDM symbols of single SRS resource are clear of PUCCH resource, i.e. non-overlapping symbols, N, out of L symbols. In other words, an assessment is made of whether, and to what extent, there is a set of SRS resource which is non-overlapping in time with allocated PUCCH resource.

If it is determined that a first set of TDM:ed single SRS resource with repetition overlaps partially with PUCCH resources, the UE may be configured, according to some implementations, to drop that single resource UL SRS transmission with the first set of TDM:ed antenna ports with repetition associated with overlapping sub-groups/OFDM symbols with SRS resource set usage codebook/non-codebook/antenna switching/beam management and/or PUSCH coherency assumption coherent/non-coherent/and prioritize PUCCH resource transmission in that first set.

If a number of remaining non-overlapping sub-groups/OFDM symbols of single SRS resources transmission is determined to be larger than, or equal to, a TDM factor S, i.e. N≥S, with at least a set of different TDM:ed antenna ports with SRS resource set usage codebook/antenna switching/beam management and/or PUSCH-transmission coherency associated with sub-groups set to partial-coherent/non-coherent, the UE may, in some implementations, perform transmission of a second set of TDM:ed antenna ports associated with sub-group/OFDM symbols, without any dropping any symbols of the second set.

If a number of remaining non-overlapping sub-groups/OFDM symbols of single SRS resources transmission is determined to be larger than, or equal to, a TDM factor S, i.e. N≥S, andif at least a set of different TDM:ed antenna ports with SRS resource set usage non-codebook/codebook and/or PUSCH-transmission coherency associated with a sub-group is set to fully-coherent, the UE may, in some implementations, perform transmission of SRS in relation to a sub-set of a second set of TDM: ed antenna ports associated with sub-group/OFDM symbols and drop a remaining part of the second set. The sub-set of the second set of TDM:ed antenna ports may correspond to antenna ports associated with a full-set of TDM:ed antenna ports associated with consecutive sub-groups/OFDM symbols. E.g. {1,2, . . . , s}.

If a number of remaining non-overlapping sub-groups/OFDM symbols of single SRS resources transmission is determined to be less than, TDM factor s, i.e. N<S, with at least one full set of different TDM:ed antenna ports with SRS resource set usage codebook/non-codebook/antenna switching/beam management and PUSCH-transmission coherency associated with sub-groups set to fully-coherent/partial-coherent/non-coherent, the UE may be configured to drop the entire single resource UL SRS transmission associated with a configured/indicated transmission occasion.

It will be appreciated that it is determined by gNB implementation as to whether, and how, the set of TDM:ed antenna ports associated with non-overlapping OFDM symbols are utilized.

It will further be appreciated that it is important that there is a common understanding between gNB and UE as to which TDM:ed antenna ports associated with repetition are transmitted and which are not.

It will also be appreciated that the described methods and mechanisms can be applied in relation to UL SRS resource sets configured with usage: ‘codebook’ or ‘non-codebook’ or ‘antennaSwitching’ or ‘beamManagement’.

According to an alternative implementation of an arrangement, a transmission rule-set to be applied in relation to single resource UL SRS with TDM:ed antenna ports and repetition with partially overlapping PUCCH transmission is defined.

If it is determined that a first set of TDM: ed single SRS resource with repetition overlaps partially with, for example, PUCCH resources with format 1/2/3, the UE may be configured to drop single resource UL SRS transmission in the first set of TDM:ed antenna ports with repetition associated with overlapping sub-groups/OFDM symbols and instead prioritize PUCCH resource transmission.

If it is determined that a number of remaining non-overlapping sub-groups/OFDM symbols of single SRS resources transmission is larger than, or equal to, TDM factor s, with at least one full set of different TDM:ed antenna ports and PUSCH-transmission coherency associated with sub-groups set to fully-coherent/partial-coherent/non-coherent, then the UE may be configured to prioritize transmission of the SRS of the dropped TDM:ed antenna ports (ie those of the first set, which were dropped in favour of PUCCH transmission) on the remaining non-overlapping sub-groups/OFDM symbols. The UE may also be configured to transmit a SRS relating to a third set of TDM:ed antenna ports where the UE determines that the third set of TDM:ed antenna ports for single resource SRS transmission are such that the first and third set together define an equal number of repeated antenna ports over a time duration of single SRS resource with repetition that are all TDM:ed.

If it is determined that a number of remaining non-overlapping sub-groups/OFDM symbols of single SRS resources transmission is less than TDM factor s, with at least one full set of different TDM:ed antenna ports and PUSCH-transmission coherency associated with sub-groups set to fully-coherent/partial-coherent/non-coherent, then the UE may be configured to UE drop single resource UL SRS transmission associated with configured/indicated transmission occasion.

In support of described arrangements, a new SRS resource-specific RRC parameter can be defined which offers an indication of whether a UE and gNB can enable configuration/indication of an alternative rule-set to be used in relation to single resource SRS transmission with TDM: ed antenna ports and repetition.

Further rules may also be applied in accordance with some implementations of arrangements. For example, according to one implementation, a UE may be configured to apply the dropping rules in conjunction with a transmission power limitation rule. For example, if a UE determines, after first applying the adequate transmission power for PUCCH, that the UE could multiplex the PUCCH and SRS because, despite a possible power limitation, it is able to apply adequate transmission power for SRS transmission, then it may be configured to do so. In other words, if the UE determines that both SRS and PUCCH can be transmitted with adequate power (that is sufficient for UL coverage) then the UE may be configured not to drop the SRS transmission, despite overlap.

In one possible implementation of an arrangement, a UE may be configured such that an SRS transmission on symbols which overlap, for example, with PUCCH may be dropped if the spatial relation (a Quasi Co Location (QCL) assumption for uplink transmission) for the PUCCH transmission and SRS transmission is not the same (for example, if a different Downlink Reference Signal (DL RS) is used as spatial relation for the UL transmission).

In one possible implementation of an example, if a UE does not support or is not capable of transmitting UL transmissions across multiple panels and has to select one for transmission, the UE may be configured, irrespective of the rule set described above, such that SRS transmission on the overlapping symbol, for example, with PUCCH, is dropped.

In one possible example implementation of an arrangement, the dropping ruleset may be applied in dependence upon, for example, SRS resource time type. For example, for an aperiodic SRS a UE may be configured such that the dropping rule is not applied. Alternatively, the PUCCH transmission can be dropped. Similarly, if a UE is configured to apply a periodic SRS transmission, a dropping ruleset as described above may be applied in relation to SRS transmission which occurs on overlapping symbols.

In one possible example implementation of an arrangement, if it is determined that the transmission, for example, PUCCH transmission, is transmitted in accordance with a repetition rule, a UE may be configured such that a dropping ruleset can be applied on a “per PUCCH transmission instance” basis. In other words, the dropping ruleset is applied for each symbol in which the PUCCH transmission is repeated.

FIG. 3 illustrates schematically an example embodiment of the subject matter described herein. FIG. 3 illustrates schematically one slot 10 of an example implementation of an arrangement in which a PUCCH 50 is scheduled to be transmitted by a UE in a manner which would result in a partial overlap, in symbol #2 60 with a scheduled UL SRS with TDM antenna ports and repetitions, as shown. In particular, the UE of FIG. 3 comprises a Rel-18 UE which is configured with single UL SRS resource with 8 TDM:ed antenna ports having TDM factor=2 over two different sub-groups and operating with repetition (in this case, R=repetitionFactor=n4). The UE is configured to assume that a total number of UL SRS antenna ports per resource (defined by information element ‘nmbSRS-Ports’) is equally distributed across 8 consecutive OFDM symbols and each symbol is associated with a TDM antenna port set with (nmbSRS-Ports/(Ns/R)) antenna ports, as defined by Rel-17 information element “nmbOfSymbols” where the starting OFDM symbol is defined by information element, for example, startPosition=1.

In the example implementation shown in FIG. 3, the PUCCH transmission 50 is configured which partially overlaps with a periodic/semi-persistent UL SRS transmission with TDM:ed antenna ports. As shown in FIG. 3, the partial overlap occurs on the 2^{nd} symbol of the full-set of sub-groups associated with TDM factor. As a result, in accordance with a rule set according to described arrangements, a UE is configured such that it determines that the total number of non-overlapping symbols/subgroups is 7 (of a total of 8 available symbols). The UE is further configured to make an assessment of whether the number of clear (non-overlapping) symbols is greater or equal to, or less than the time domain multiplexing factor associated with the single resource SRS transmission. In this case, 7>4. As a result, the UE is configured to drops the single resource UL SRS transmission containing information relating to a first set of TDM:ed antenna ports which overlaps with the PUCCH 50 in slot 60 and prioritizes PUCCH resource transmission in that slot. By prioritizing transmission of PUCCH and dropping the SRS transmission in slot 2, the UE drops transmission of UL SRS relating to TDM:ed antenna ports 4 to 7.

In accordance with the described rulesets in accordance with arrangements, the UE is configured to determine what action to take in relation to the remaining SRS resource set. Since, in the case illustrated, the number of remaining non-overlapping sub-groups/OFDM symbols of single SRS resources transmission is larger or equal to TDM factor 4 with at least one full set of different TDM: ed antenna ports, the UE is configured such that it continues/retains transmission of a further set of TDM:ed antenna ports associated with sub-group/OFDM symbols without dropping the SRS. That is to say, in the implementation illustrated in FIG. 3 the UE is configured to retain or continue scheduled TDM:ed UL SRS transmission relating to Antenna Ports 0 to 7 over the non-overlapping sub-groups/OFDM symbols: namely symbols 1 and 3 to 8.

It will be appreciated that arrangements may enable a reduction of UL SRS latency and resource overhead if compared to legacy “dropping” behaviour. Arrangements may enable a reduction in computational complexity at a network scheduler. Arrangements may enable improved UL CSI and DL CSI acquisition by allowing a degree of coexistence between a SRS and a PUCCH, in particular when a SRS is determined to partially overlap, for example, with PUCCH.

It will be understood that arrangements described may provide a UE device which is configured to: obtain, from a network, configuration information for a single resource sounding reference transmission. The UE may be configured to: determine, based on the configuration information, one or more overlapping symbols and one or more non-overlapping symbols for the single resource SRS transmission, wherein the single resource SRS transmission are to be overlapped with a PUCCH transmission on the one or more overlapping symbols and not to be overlapped with the PUCCH transmission on one or more non-overlapping symbols. The UE may be configured to drop, based on the determining and a number of the one or more non-overlapping symbols, at least a part of the single resource SRS transmission.

Where the UE determines that the number of non-overlapping symbols is less than a time domain multiplexing factor associated with the single resource SRS transmission it may be configured to drop, based on determining that the number of non-overlapping symbols is less than the time domain multiplexing factor, the single resource SRS transmission.

Where the UE determines that the number of non-overlapping symbols is larger than or equal to a time domain multiplexing factor associated with the single resource SRS transmission; the UE may be configured to drop, based on the determining that the number of non-overlapping symbols is larger than or equal to the time domain multiplexing factor, the single resource SRS transmission on the one or more overlapping symbols; and transmit, based on the determining that the number of non-overlapping symbols is larger than or equal to the time domain multiplexing factor and to network, the single resource SRS transmission on the one or more non-overlapping symbols.

Where the UE determines that the number of non-overlapping symbols is larger than or equal to a time domain multiplexing factor associated with the single resource SRS transmission; the UE may be configured to drop, based on the determining that the number of non-overlapping symbols is larger than or equal to the time domain multiplexing factor, the single resource SRS transmission on the one or more overlapping symbols; and transmit, based on the determining that the number of non-overlapping symbols is larger than or equal to the time domain multiplexing factor and to network, another, further, reconfigured, or reformulated, SRS transmission on the one or more non-overlapping symbols.

The another, further, reconfigured or reformulated SRS transmission may define an equal number of repeated time domain multiplexed antenna ports to that of the un-reformulated SRS transmission, and those may be defined over a time duration of the single resource SRS transmission and comprise the information otherwise contained in a part of the original single resource SRS transmission which was dropped on the one or more overlapping symbols.

The UE may be configured to obtain, from network, an indication or configuration which indicates how the another further, reconfigured or reformulated SRS transmission is to be transmitted by the UE on the one or more non-overlapping symbols.

FIG. 4 illustrates schematically some components of a wireless communication network including nodes according to some arrangements; and FIG. 5 illustrates schematically steps of methods performed at network nodes in accordance with some arrangements. FIG. 4 illustrates schematically some components of a network including nodes according to some arrangements. The network 1000 comprises a plurality of network nodes 1200 in communication with user equipment 1100.

The user equipment 1100 takes the form of an apparatus, comprising: circuitry 1110 configured to receive an indication of a configuration for a single resource sounding reference signal transmission; circuitry 1120 configured to determine, based on the indication, transmission resource allocated to the single resource sounding reference signal transmission; circuitry 1130 configured to receive an indication of transmission resource allocated to a physical uplink control channel transmission; circuitry 1140 configured to evaluate an extent of an overlap between the transmission resource allocated to a physical uplink control channel transmission and the transmission resource allocated to the single resource sounding reference signal; and circuitry 1150 configured to select, based on the extent of overlap, what to transmit in the transmission resource allocated to the single resource sounding reference signal transmission.

The network access node 1200 takes the form of an apparatus, comprising: circuitry 1210 configured to determine an indication of a configuration for a single resource sounding reference signal transmission; the configuration comprising: one or more condition to be applied by a mobile network node to select what to transmit in transmission resource allocated to the single resource sounding reference signal transmission, the selection being based upon an evaluated extent of an overlap between transmission resource allocated to a physical uplink control channel transmission and the transmission resource allocated to the single resource sounding reference signal transmission; and circuitry 1220 configured to provide the determined indication to the mobile network node.

FIG. 5 illustrates schematically steps of methods performed at some network nodes in accordance with some arrangements.

The user equipment 1100 may be configured to perform a method comprising the steps of:
5110: receiving an indication of a configuration for a single resource sounding reference signal transmission;
5120: determining, based on the indication, transmission resource allocated to the single resource sounding reference signal transmission;
5130: receiving an indication of transmission resource allocated to a physical uplink control channel transmission;
5140: evaluating an extent of an overlap between the transmission resource allocated to a physical uplink control channel transmission and the transmission resource allocated to the single resource sounding reference signal transmission; and
5150: selecting, based on the extent of overlap, what to transmit in the transmission resource allocated to the single resource sounding reference signal transmission.

The network node 1200 may be configured to perform a method comprising the steps of:
5210: determining an indication of a configuration for a single resource sounding reference signal transmission; the configuration comprising: one or more condition to be applied by a mobile network node to select what to transmit in transmission resource allocated to the single resource sounding reference signal transmission, the selection being based upon an evaluated extent of an overlap between transmission resource allocated to a physical uplink control channel transmission and the transmission resource allocated to the single resource sounding reference signal transmission; and
5220: providing the determined indication to the mobile network node.

A person of skill in the art would readily recognize that steps of various above-described methods can be performed by programmed computers. Herein, some embodiments are also intended to cover program storage devices, e.g., digital data storage media, which are machine or computer readable and encode machine-executable or computer-executable programs of instructions, wherein said instructions perform some or all of the steps of said above-described methods. The program storage devices may be, e.g., digital memories, magnetic storage media such as a magnetic disks and magnetic tapes, hard drives, or optically readable digital data storage media. The embodiments are also intended to cover computers programmed to perform said steps of the above-described methods. The tern non-transitory as used herein, is a limitation of the medium itself (i.e., tangible, not a signal) as opposed to a limitation on data storage persistency (e.g. RAM vs ROM).

As used in this application, the term “circuitry” may refer to one or more or all of the following:
(a) hardware-only circuit implementations (such as implementations in only analog and/or digital circuitry) and
(b) combinations of hardware circuits and software, such as (as applicable):
   (i) a combination of analog and/or digital hardware circuit(s) with software/firmware and
   (ii) any portions of hardware processor(s) with software (including digital signal processor(s)), software, and memory(ies) that work together to cause an apparatus, such as a mobile phone or server, to perform various functions) and
(c) hardware circuit(s) and or processor(s), such as a microprocessor(s) or a portion of a microprocessor(s), that requires software (e.g., firmware) for operation, but the software may not be present when it is not needed for operation.

This definition of circuitry applies to all uses of this term in this application, including in any claims. As a further example, as used in this application, the term circuitry also covers an implementation of merely a hardware circuit or processor (or multiple processors) or portion of a hardware circuit or processor and its (or their) accompanying software and/or firmware. The term circuitry also covers, for example and if applicable to the particular claim element, a baseband integrated circuit or processor integrated circuit for a mobile device or a similar integrated circuit in server, a cellular network device, or other computing or network device.

Although example embodiments of the present invention have been described in the preceding paragraphs with reference to various examples, it should be appreciated that modifications to the examples given can be made without departing from the scope of the invention as claimed.

Features described in the preceding description may be used in combinations other than the combinations explicitly described.

Although functions have been described with reference to certain features, those functions may be performable by other features whether described or not.

Although features have been described with reference to certain embodiments, those features may also be present in other embodiments whether described or not.

Whilst endeavouring in the foregoing specification to draw attention to those features of the invention believed to be of particular importance it should be understood that the Applicant claims protection in respect of any patentable feature or combination of features hereinbefore referred to and/or shown in the drawings whether or not particular emphasis has been placed thereon.

1-18. (canceled)

19. A mobile network node comprising:
at least one processor; and
at least one memory storing instructions that, when executed by the at least one processor, cause the network node at least to:
receive an indication of a configuration for a single resource sounding reference signal transmission;
determine, based on the indication, transmission resource allocated to the single resource sounding reference signal transmission;
receive an indication of transmission resource allocated to a physical uplink control channel transmission;
evaluate an extent of an overlap between the transmission resource allocated to a physical uplink control channel transmission and the transmission resource allocated to the single resource sounding reference signal; and
select, based on the extent of overlap, what to transmit in the transmission resource allocated to the single resource sounding reference signal transmission.

20. The mobile network node according to claim 19, wherein the configuration for a single resource sounding reference signal transmission comprises: a configuration for time division multiplexed antenna ports over multiple symbols.

21. The mobile network node according to claim 19, wherein evaluating the extent of an overlap comprises: comparing a number of coincident transmission resource and non-co-incident resource between the transmission resource allocated to a physical uplink control channel transmission and the transmission resource allocated to the single resource sounding reference signal transmission.

22. The mobile network node according to claim 19, wherein the indication of a configuration for a single resource sounding reference signal transmission comprises: an indication of orthogonal frequency-division multiplexing symbols within a slot allocated to the single resource sounding reference signal transmission.

23. The mobile network node according to claim 19, wherein the indication of transmission resource allocated to a physical uplink control channel transmission comprises: an indication of orthogonal frequency-division multiplexing symbols within a slot allocated to the physical uplink control channel transmission.

24. The mobile network node according to claim 19, wherein evaluating the extent of the overlap comprises: determining whether a number of non-overlapping symbols is less than a time domain multiplexing factor associated with the single resource sounding reference signal transmission.

25. The mobile network node according to claim 24, wherein the time domain multiplexing factor comprises an indication of a subset of antenna ports mapped onto at least two symbols sharing the same frequency resource with repetition in a slot, and wherein a total number of symbols of sounding reference signal resource allocated to time division multiplexed antenna ports with repetition is given by the multiplexing factor multiplied by a repetition factor.

26. The mobile network node according to claim 19, wherein if there is evaluated to be a greater number of overlapping symbols than non-overlapping signals, then selecting comprises: transmitting the physical uplink control channel transmission in the overlapping symbols, and dropping transmission of the single resource sounding reference transmission in the non-overlapping symbols.

27. The mobile network node according to claim 19, wherein if there is evaluated that the number of overlapping symbols is equal to or less than non-overlapping symbols, then selecting comprises: transmitting the physical uplink control channel transmission in the overlapping symbols, and transmitting at least a part of the single resource sounding reference transmission in the non-overlapping symbols.

28. The mobile network node according to claim 19, wherein selecting comprises: selecting to transmit the physical uplink control channel transmission in the transmission resource allocated to the single resource sounding reference signal transmission in the overlap, and
based on the evaluated extent of overlap, the network node is caused to:
reformulate the single resource sounding reference signal transmission for transmission in the non-overlapping transmission resource allocated to the single resource sounding reference signal transmission; and
transmit the reformulated single resource sounding reference signal in the non-overlapping transmission resource allocated to the single resource sounding reference signal transmission.

29. The mobile network node according to claim 28, wherein the reformulated single resource sounding reference signal transmission comprises: an equivalent number of repeated time domain multiplexed antenna ports as that in the received configuration for a single resource sounding reference signal transmission.

30. The mobile network node according to claim 19, wherein the mobile network node is caused to:
determine whether adequate power is available for transmission of the physical uplink control channel transmission and the single resource sounding reference signal transmission within the overlap between the transmission resource allocated to a physical uplink control channel transmission and the transmission resource allocated to the single resource sounding reference signal transmission; and wherein
selecting what to transmit in the transmission resource allocated to the single resource sounding reference signal transmission is based on the extent of the overlap and the determination of whether adequate power is available.

31. The mobile network node according to claim 19, wherein the mobile network node is caused to:
determine a spatial relation between the physical uplink control channel transmission and the single resource sounding reference signal transmission; and wherein
selecting what to transmit in the transmission resource allocated to the single resource sounding reference signal transmission is based on the extent of the overlap and the determination of the spatial relation.

32. The mobile network node according to claim 19, wherein the mobile network node is caused to:
determine it has multiple panel uplink capability enabled; and wherein selecting what to transmit in the transmission resource allocated to the single resource sounding reference signal transmission is based on the extent of the overlap and whether multiple panel uplink capability is enabled.

33. A method for a mobile network node, comprising:
receiving an indication of a configuration for a single resource sounding reference signal transmission;
determining, based on the indication, transmission resource allocated to the single resource sounding reference signal transmission;
receiving an indication of transmission resource allocated to a physical uplink control channel transmission;
evaluating an extent of an overlap between the transmission resource allocated to a physical uplink control channel transmission and the transmission resource allocated to the single resource sounding reference signal transmission; and
selecting, based on the extent of overlap, what to transmit in the transmission resource allocated to the single resource sounding reference signal transmission.

34. A network node comprising:
at least one processor; and
at least one memory storing instructions that, when executed by the at least one processor, cause the network node at least to:
determine an indication of a configuration for a single resource sounding reference signal transmission;
the configuration comprising: one or more condition to be applied by a mobile network node to select what to transmit in transmission resource allocated to the single resource sounding reference signal transmission, the selection being based upon an evaluated extent of an overlap between transmission resource allocated to a physical uplink control channel transmission and the transmission resource allocated to the single resource sounding reference signal transmission; and
provide the determined indication to the mobile network node.
